(19) United States
(12) Patent Application Publication
(10) Pub. No.: US 2020/0274461 A1
(43) Pub. Date: Aug. 27, 2020

(54) ELECTRIC POWER CONVERSION DEVICE, MOTOR DRIVER, AND ELECTRIC POWER STEERING DEVICE

(71) Applicant: Nidec Corporation, Kyoto (JP)

(72) Inventors: Takashi KOIKEGAMI, Kawasaki-shi (JP); Yuhi NAKADA, Kyoto (JP); Takahiro KIKUICHI, Kyoto (JP)

(21) Appl. No.: 16/634,609

(22) PCT Filed: Jun. 11, 2018
(86) PCT No.: PCT/JP2018/022271

§ 371 Date: Jan. 28, 2020

(30) Foreign Application Priority Data
Aug. 31, 2017 (JP) 2017-167976

(51) Int. Cl. H02M 7/537

(52) U.S. Cl. CPC H02M 7/537

(57) ABSTRACT

An electric power conversion device includes a first inverter connected to one end of each phase winding of a motor, a second inverter connected to another end of each phase winding, and a control circuit to control operation of the first and second inverters. The control circuit configures a neutral point in the first inverter and applies a voltage to a path in which a high-side of the second inverter, the first-phase winding, the neutral point, the second-phase winding, and a low-side of the second inverter are connected, and diagnoses whether the first and second inverters are faulty.

### CROSS REFERENCE TO RELATED APPLICATIONS

This is a U.S. national stage of PCT Application No. PCT/JP2018/022271, filed on Jun. 11, 2018, and claiming priority under 35 U.S.C. § 119(a) and 35 U.S.C. § 365(b) to Japanese Application No. 2017-167976, filed Aug. 31, 2017, the entire disclosures of which are hereby incorporated herein by reference.

### 1. FIELD OF THE INVENTION

The present disclosure relates to an electric power conversion device that converts electric power supplied to an electric motor, and a motor driver, and an electric power steering device.

### 2. BACKGROUND

An electric motor (hereinafter, simply referred to as “motor”), such as a brushless DC motor and an AC synchronous motor, is typically driven by a three-phase current. A complex control technology, such as a vector control and the like, is used to accurately control the waveform of the three-phase current. Such control technology requires highly mathematical arithmetic and employs a digital arithmetic circuit such as a microcontroller (a microcomputer) and the like. A vector control technology has been utilized in a field where load variation of the motor is large, for example, in fields of washing machines, electric assist bicycles, electric scooters, electric power steering devices, electric vehicles, industrial machinery, and the like. On the other hand, other motor control methods such as a pulse width modulation (PWM) method have been employed for motors with relatively small outputs.

In an automotive mounting field, an electrical control unit (ECU) for automobiles is used for vehicles. The ECU includes a microcontroller, a power source, an input/output circuit, an A/D converter, a load driving circuit, a ROM (Read Only Memory), and the like. An electronic control system is constructed with the ECU as a core. For example, the ECU processes a signal from a sensor to control an actuator such as a motor or the like. Specifically, the ECU controls an inverter in an electric power conversion device while monitoring a rotational speed or a torque of the motor. Under control performed by the ECU, the electric power conversion device converts driving electric power supplied to the motor.

Recently, a mechanically and electrically integrated type motor in which a motor, an electric power conversion device and the ECU are integrated has been developed. Particularly, in the automotive mounting field, high-quality assurance is required from viewpoint of safety. For this reason, a redundant design making it possible to continue safe operation even when some of the components are faulty has been introduced. As one example of the redundant design, it has been considered to provide two electric power conversion devices for one motor. As another example, it has been considered to provide a backup microcontroller in a main microcontroller.

For example, an electric power conversion device including a controller, two inverters, and converting electric power supplied to a three-phase motor is known in a related art. Each of the two inverters is connected to a power source and a ground (hereinafter, referred to as “GND”). One inverter is connected to one end of the three-phase winding of the motor, and the other inverter is connected to the other end of the three-phase winding. Each inverter includes a bridge circuit composed of three legs of which each leg includes a high-side switching element and a low-side switching element. When detecting a fault of the switching elements in the two inverters, a controller switches a motor control from a control at the normal times to a control at the abnormal times. In the present specification, the term “abnormal” mainly means a fault of the switching element. Also, the term “control at the normal times” means a control in the state in which all the switching elements are normal, and the term “control at the abnormal times” means a control in a state in which a fault occurs in any switching element.

In control at the abnormal times, a neutral point of the winding is configured by turning on and off the switching elements according to a predetermined rule in the inverter (hereinafter referred to as a “faulty inverter”) including a faulty switching element among the two inverters. According to the predetermined rule, for example, when an open-fault by which the high-side switching element is always turned off is generated, the switching elements other than the faulty switching element among the three high-side switching elements in a bridge circuit of the inverter are turned off, and the three low-side switching elements are turned on. In this case, the neutral point is configured in the low-side side. Alternatively, when a short-fault by which the high-side switching element is always turned on is generated, the switching elements other than the faulty switching element among the three high-side switching elements in the bridge circuit of the inverter are turned on, and the three low-side switching elements are turned off. In this case, the neutral point is configured on the high-side side.

According to a related electric power conversion device, the neutral point of the three-phase winding is configured in the faulty inverter at the abnormal times. Even if a fault occurs in the switching element, it is possible to continue to drive the motor using the normal inverter.

In the device that drives a motor using two inverters as described above, when a fault occurs in the inverter, it is required to specify a fault location.

In another related art, a device for driving a motor having a Y-connected winding with one inverter is known. In another related art, a configuration, in which a detected signal in a predetermined energization pattern is compared against a corresponding table containing kinds of predetermined abnormality, and thereby a disconnection of wiring and a short circuit are detected, is known.

However, in the technology of another related art, when a fault occurs in a switching element included in the inverter, it is not possible to specify which switching element among the plurality of switching elements is faulty.

In a device that drives a motor using two inverters, when a fault occurs in a switching element, it is required to specify which switching element among the plurality of switching elements is faulty.

### SUMMARY

An electric power conversion device according to an example embodiment of the present disclosure is an electric power conversion device converting electric power from a power source into electric power to be supplied to a motor including an n-phase winding where n is an integer greater than or equal to 3, the electric power conversion device including a first inverter connected to one end of each of the n-phase winding, a second inverter connected to another end of each of the n-phase winding, and a control circuit to control operation of the first inverter and the second inverter. Each of the first inverter and the second inverter includes a plurality of switching elements, the n-phase winding includes a first-phase winding, a second-phase winding, and a third phase winding, and the control circuit defines a neutral point in the first inverter and applies a voltage to a path in which a high-side of the second inverter, the first-phase winding, the neutral point, the second-phase winding, and a low-side of the second inverter are connected to and diagnoses whether the first and second inverters are faulty.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a circuit diagram showing a circuit configuration of an electric power conversion device 100 according to a first example embodiment of the present disclosure.

FIG. 2 is a circuit diagram showing another circuit configuration of the electric power conversion device 100 according to the first example embodiment of the present disclosure.

FIG. 3 is a circuit diagram showing still another circuit configuration of the electric power conversion device 100 according to the first example embodiment of the present disclosure.

FIG. 4 is a circuit diagram showing yet another circuit configuration of the electric power conversion device 100 according to the first example embodiment of the present disclosure.

FIG. 5 is a block diagram showing a typical configuration of a motor driver 400 provided with the electric power conversion device 100.

FIG. 6 is a diagram showing current waveforms (sine waves) obtained by plotting values of current flowing through each of windings of U-phase, V-phase, and W-phase of the motor 200, when the electric power conversion device 100 is controlled in accordance with a three-phase energization control.

FIG. 7 is a schematic diagram showing a current flow in the electric power conversion device 100 when two switching circuits 110 and FETs of a first inverter 120 are in a first state.

FIG. 8 is a diagram showing current waveforms obtained by plotting values of currents flowing through each of windings of U-phase, V-phase, and W-phase of the motor 200, when the electric power conversion device 100 is controlled in the first state.

FIG. 9 is a schematic diagram showing a current flow in the electric power conversion device 100 when the two switching circuits 110 and the FETs of the first inverter 120 are in a third state.

FIG. 10 is a diagram showing an example of an operation of performing a fault diagnosis by providing a neutral point on a low-side.

FIG. 11 is a diagram showing FETs included in the first and second inverters 120 and 130.

FIG. 12 is a diagram showing a relationship between a switching element to be turned on and a switching element to be diagnosed in the second inverter 130 when the neutral point is configured on the low-side.

FIG. 13 is a diagram explaining fault diagnosis when FETs 132H and 133L are turned on.

FIG. 14 is a diagram explaining fault diagnosis when FETs 133H and 131L are turned on.

FIG. 15 is a diagram showing an example of an operation of performing fault diagnosis by configuring the neutral point on a high-side.

FIG. 16 is a diagram showing a relationship between a switching element to be turned on and a switching element to be diagnosed in the second inverter 130 when the neutral point is configured on the high-side.

FIG. 17 is a diagram explaining fault diagnosis when the FETs 132H and 133L are turned on.

FIG. 18 is a diagram explaining fault diagnosis when the FETs 133H and 131L are turned on.

FIG. 19 is a schematic diagram showing a typical configuration of an electric power steering device 500 according to a second example embodiment of the present disclosure.

### DETAILED DESCRIPTION

Hereinafter, example embodiments of electric power conversion devices, motor drivers, and electric power steering devices of the present disclosure will be described in details with reference to the accompanying drawings. However, description which is detailed more than necessary may be omitted. For example, detailed descriptions of already well-known items and duplicate descriptions of substantially the same configurations may be omitted. This is to avoid unnecessarily redundant description and to facilitate understanding by those skilled in the art.

In this specification, an example embodiment of the present disclosure will be described with reference to an example of an electric power conversion device for converting an electric power supplied to a three-phase motor having three-phases (U-phase, V-phase, and W-phase) windings. However, an electric power conversion device for converting an electric power supplied to a n-phase motor having n-phase (where “n” is an integer greater than or equal to 4) windings such as four-phase, five-phase or the like is also within the scope of the present disclosure.

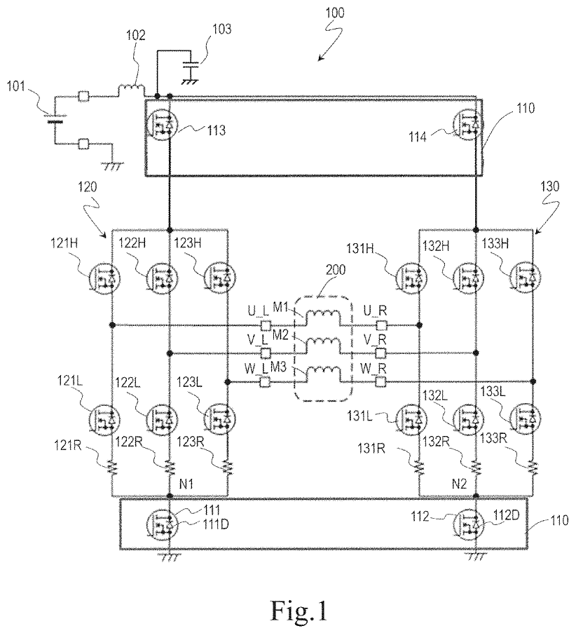

FIG. 1 schematically shows a circuit configuration of an electric power conversion device 100 according to a first example embodiment of the present disclosure.

The electric power conversion device 100 includes two switching circuits 110, a first inverter 120, and a second inverter 130. The electric power conversion device 100 may convert electric power supplied to various motors. A motor 200 is a three-phase AC motor.

The motor 200 includes a U-phase winding M1, a V-phase winding M2, and a W-phase winding M3, and is connected to the first inverter 120 and the second inverter 130. Specifically, the first inverter 120 is connected to one end of each of the phase windings of the motor 200, and the second inverter 130 is connected to the other end of each of the phase windings. In the present specification, “connection” between parts (components) mainly means an electrical connection. The first inverter 120 has terminals U_L, V_L, and W_L corresponding to each phase, respectively, and the second inverter 130 has terminals U_R, V_R, and W_R corresponding to each phase.

The terminal U_L of the first inverter 120 is connected to one end of the U-phase winding M1, the terminal V_L is connected to one end of the V-phase winding M2, and the terminal W_L is connected to one end of the W-phase winding M3. Similar to the first inverter 120, the terminal U_R of the second inverter 130 is connected to the other end of the U-phase winding M1, the terminal V_R is connected to the other end of the V-phase winding M2, and the terminal W_R is connected to the other end of the W-phase winding M3. Such connections between the inverter and the motor differ from so-called a star connection and a delta connection.

The two switching circuits 110 include switch elements 111, 112, 113 and 114. In the present specification, in the two switching circuits 110, the GND-side switching circuit 110 on which the switch elements 111 and 112 are provided is referred to as a “GND-side switching circuit”, and the power source-side switching circuit 110 on which the switch elements 113 and 114 are provided is referred to as a “power source-side switching circuit”. That is, the GND-side switching circuit has the switch elements 111 and 112, and the power source-side switching circuit has the switch elements 113 and 114.

In the electric power conversion device 100, the first inverter 120 and the second inverter 130 may be electrically connected to a power source 101 and a GND by the two switching circuits 110.

Specifically, the switch element 111 switches a connection/disconnection between the first inverter 120 and the GND. The switch element 112 switches a connection/disconnection between the second inverter 130 and the GND. The switch element 113 switches a connection/disconnection between the power source 101 and the first inverter 120. The switch element 114 switches a connection/disconnection between the power source 101 and the second inverter 130.

A turn-on and turn-off of the switch elements 111, 112, 113 and 114 may be controlled, for example, by a microcontroller or a dedicated driver. The switch elements 111, 112, 113, and 114 are able to block bidirectional current. For example, semiconductor switches such as thyristors and analog switch ICs, and the like, mechanical relays, and the like may be employed as the switch elements 111, 112, 113, and 114. A combination of a diode and an insulated gate bipolar transistor (IGBT) may be used. However, the switch element according to present disclosure includes a semiconductor switch such as a field effect transistor (typically MOSFET) in which a parasitic diode is formed, or the like. Hereinafter, an example in which FETs are employed as the switch elements 111, 112, 113, and 114 will be described, and the switch elements 111, 112, 113, and 114 will be denoted as FETs 111, 112, 113, and 114, respectively.

The FETs 111 and 112 have parasitic diodes 111D and 112D, respectively, and are disposed so that the parasitic diodes 111D and 112D face the first and second inverters 120 and 130, respectively. More specifically, the FET 111 is disposed so that a forward current flows towards the first inverter 120 in the parasitic diode 111D, and the FET 112 is disposed so that a forward current flows towards the second inverter 130 in the parasitic diode 112D.

The number of switch elements to be used is not limited to the illustrated example, and is appropriately determined in consideration of a design specification and the like. In particular, since high quality assurance is required from the viewpoint of safety in an automotive mounting field, it is preferred to provide the plurality of switch elements for each inverter in the power source-side switching circuit and the GND-side switching circuit.

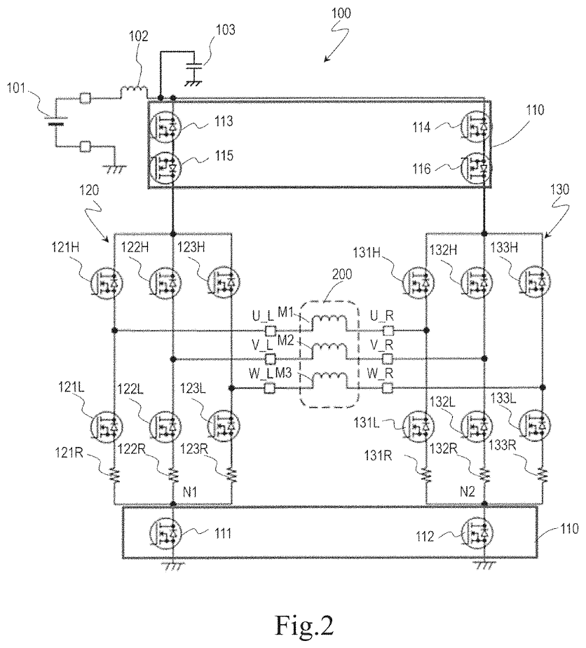

FIG. 2 schematically shows another circuit configuration of the electric power conversion device 100 according to the example embodiment of the present disclosure.

The power source-side switching circuit 110 may further include a switch element (FET) 115 for reverse-connection protection and a switch element (FET) 116 for reverse-connection protection. The FETs 113, 114, 115, and 116 have parasitic diodes, and are disposed so that directions of the parasitic diodes in the FETs face each other. More specifically, the FET 113 is disposed so that a forward current flows towards the power source 101 in the parasitic diode, and the FET 115 is disposed so that a forward current flows towards the first inverter 120 in the parasitic diode. The FET 114 is disposed so that a forward current flows towards the power source 101 in the parasitic diode, and the FET 116 is disposed so that a forward current flows towards the second inverter 130 in the parasitic diode. Even when the power source 101 is connected in a reverse direction, a reverse current may be blocked by the two FETs for reverse-connection protection.

The power source 101 generates a predetermined power supply voltage. As the power source 101, for example, a DC power source is used. However, the power source 101 may be an AC-DC converter and a DC-DC converter, or may be a battery (a storage battery).

The power source 101 may be a single power source common to the first and second inverters 120 and 130, or may include a first power source for the first inverter 120 and a second power source for the second inverter 130.

A coil 102 is provided between the power source 101 and the power source-side switching circuit 110. The coil 102 functions as a noise filter, and smoothens high-frequency noise included in a voltage waveform supplied to each inverter or high-frequency noise generated in each inverter so as not to flow out to the power source 101 side. In addition, a capacitor 103 is connected between the power source 101 and each inverter. In the illustrated example embodiment of the present disclosure, the capacitor 103 is connected between the coil 102 and the power source-side switching circuit 110. The capacitor 103 is a so-called bypass capacitor and suppresses voltage ripple. The capacitor 103 is, for example, an electrolytic capacitor, and the capacitance and the number of the capacitor 103 to be used are appropriately determined according to design specifications and the like.

The first inverter 120 (may be referred to as a “bridge circuit L”) includes a bridge circuit composed of three legs. Each leg has a low-side switching element and a high-side switching element. Switching elements 121L, 122L, and 123L shown in FIG. 1 are low-side switching elements, and switching elements 121H, 122H, and 123H are high-side switching elements. For example, a FET or IGBT may be employed as the switching element. Hereinafter, an example in which the FET is employed as the switching element will be described, and the switching element may be referred to as the FET. For example, the switching elements 121L, 122L, and 123L are referred to as the FETs 121L, 122L, and 123L.

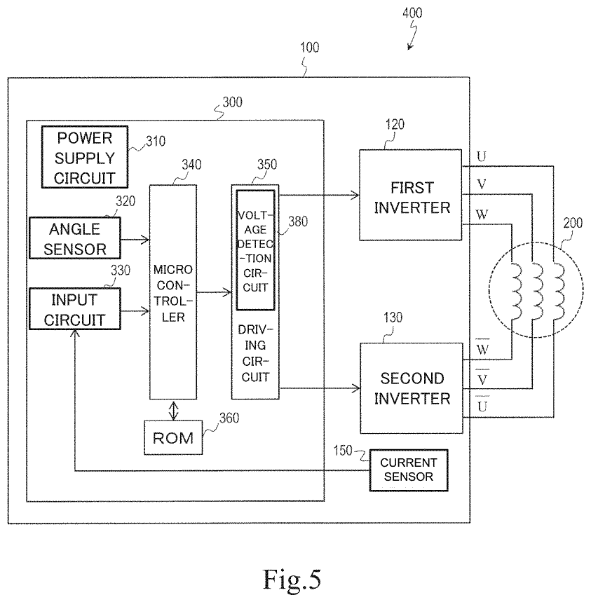

The first inverter 120 includes three shunt resistors 121R, 122R, and 123R as current sensors (see FIG. 5) for detecting currents flowing in the winding of each of the U-phase, the V-phase, and the W-phase. A current sensor 150 includes a current detection circuit (not shown) for detecting a current flowing through each shunt resistor. For example, the shunt resistors 121R, 122R, and 123R are connected between the three low-side switching elements included in the three legs of the first inverter 120 and the GND, respectively. Specifically, the shunt resistor 121R is electrically connected between the FET 121L and the FET 111, the shunt resistor 122R is electrically connected between the FET 122L and the FET 111, and the shunt resistor 123R is electrically connected between the FET 123L and the FET 111. A resistance value of the shunt resistor is, for example, about 0.5 mΩ to 1.0 mΩ.

Similar to the first inverter 120, the second inverter 130 (may be referred to as a “bridge circuit R”) includes a bridge circuit composed of three legs. FETs 131L, 132L and 133L shown in FIG. 1 are low-side switching elements, and FETs 131H, 132H and 133H are high-side switching elements. Also, the second inverter 130 includes three shunt resistors 131R, 132R, and 133R. The shunt resistors of the inverters are connected between the three low-side switching elements included in the three legs and the GND. Each FET of the first and second inverters 120 and 130 may be controlled by, for example, a microcontroller or a dedicated driver.

FIG. 1 illustrates a configuration in which one shunt resistor is disposed in each leg in each inverter. However, the first and second inverters 120 and 130 may be provided with six or less shunt resistors. For example, six or less shunt resistors may be connected between six or less low-side switching elements among six legs provided in the first and second inverters 120 and 130, and the GND. In addition, when this configuration is expanded to a n-phase motor, the first and second inverters 120 and 130 may include 2n or less shunt resistors. For example, 2n or less shunt resistors may be connected between 2n or less low-side switching elements among 2n legs provided in the first and second inverters 120 and 130, and the GND.

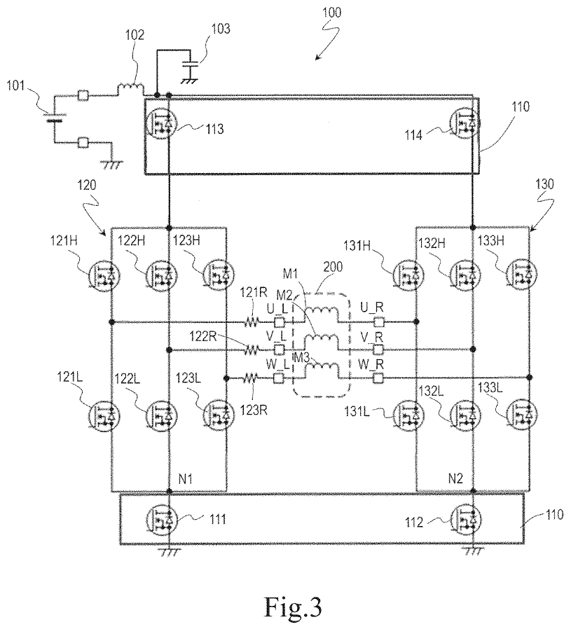

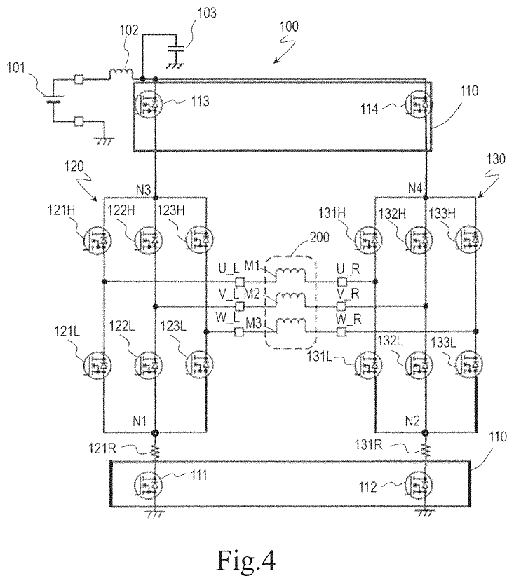

FIGS. 3 and 4 schematically show still another circuit configuration of the electric power conversion device 100 according to the example embodiment of the present disclosure.

As shown in FIG. 3, it is also possible to dispose three shunt resistors between each leg of the first or second inverter 120, 130 and the windings M1, M2, and M3. For example, the shunt resistors 121R, 122R, and 123R may be disposed between the first inverter 120 and one end of the windings M1, M2, and M3. In addition, for example, although not shown, the shunt resistors 121R and 122R may be disposed between the first inverter 120 and the one end of the windings M1 and M2, and the shunt resistor 123R may be disposed between the second inverter 130 and the other end of the winding M3. In such a configuration, it is sufficient if three shunt resistors are disposed for the U, V, and W phases, and at least two shunt resistors may be disposed.

As shown in FIG. 4, for example, only one shunt resistor common to each phase winding may be disposed in each inverter. One shunt resistor is electrically connected, for example, between a node N1 (a connecting point of each leg) of the low-side side of the first inverter 120 and the FET 111, and the other one shunt resistor may be electrically connected, for example, between a node N2 of the low-side side of the second inverter 130 and the FET 112.

Alternatively, similar to the low-side side, one shunt resistor is electrically connected, for example, between a node N3 of the high-side side of the first inverter 120 and the FET 113, and the other shunt resistor is electrically connected, for example, between a node N4 of the high-side side of the second inverter 130 and the FET 114. As described above, the number of shunt resistors to be used and the disposal of the shunt resistors are appropriately determined in consideration of product cost, design specifications, and the like.

FIG. 5 schematically shows a typical block configuration of a motor driver 400 provided with the electric power conversion device 100.

The motor driver 400 includes the electric power conversion device 100 and the motor 200. The electric power conversion device 100 includes a control circuit 300. The control circuit 300 may be provided as a component different from the electric power conversion device 100.

The control circuit 300 includes, for example, a power supply circuit 310, an angle sensor 320, an input circuit 330, a microcontroller 340, a driving circuit 350, and a ROM 360. The control circuit 300 is connected to the electric power conversion device 100 and drives the motor 200 by controlling the electric power conversion device 100.

Specifically, the control circuit 300 may control a position, a rotational speed, a current, and the like of a target rotor and thereby realize a closed-loop control. In addition, the control circuit 300 may be provided with a torque sensor instead of the angle sensor. In this case, the control circuit 300 may control a target motor torque.

The power supply circuit 310 generates a DC voltage (e.g., 3V and 5V) required for respective block in a circuit. The angle sensor 320 is, for example, a resolver or a hall IC. The angle sensor 320 detects a rotation angle (hereinafter, referred to as a “rotational signal”) of the rotor of the motor 200, and outputs the rotational signal to the microcontroller 340. The input circuit 330 receives a motor current value (hereinafter, referred to as an “actual current value”) detected by the current sensor 150, converts a level of the actual current value into an input level of the microcontroller 340, as necessary, and outputs the actual current value to the microcontroller 340.

The microcontroller 340 controls switching operation (turn-on or turn-off) of each FET in the first and second inverters 120 and 130 of the electric power conversion device 100. The microcontroller 340 sets a target current value according to the actual current value, the rotational signal of the rotor, and the like, generates a PWM signal, and outputs the PWM signal to the driving circuit 350. In addition, the microcontroller 340 may control the turn-on and turn-off of each FET in the two switching circuits 110 of the electric power conversion device 100.

The driving circuit 350 is typically a gate driver. The driving circuit 350 generates a control signal (gate control signal) for controlling the switching operation of each FET in the first and second inverters 120 and 130 according to the PWM signal, and provides the control signal to a gate of each FET. Further, the driving circuit 350 may generate the control signal (gate control signal) for controlling the turn-on and turn-off of each FET in the two switching circuits 110, according to an instruction from the microcontroller 340, and provide the gate of each FET with the control signal.

The driving circuit 350 is provided with a voltage detection circuit 380. For example, the voltage detection circuit 380 detects a voltage between a source and a drain of each FET included in the first and second inverters 120 and 130. Further, for example, as described later, the voltage of each of the U-phase, the-V phase, and the W-phase is detected.

In addition, the microcontroller may execute control of the FETs of the two switching circuits 110. Furthermore, the microcontroller 340 may have the function of the driving circuit 350. In that case, the control circuit 300 may not include the drive circuit 350.

The ROM 360 is, for example, a writable memory, a rewritable memory, or a read-only memory. The ROM 360 stores a control program including an instruction group for causing the microcontroller 340 to control the electric power conversion device 100. For example, the control program is temporarily deployed in a RAM (not shown) at the time of booting.

The electric power conversion device 100 has a control at the normal times and a control at the abnormal times. The control circuit 300 (mainly the microcontroller 340) may switch control of the electric power conversion device 100 from control at the normal times to control at the abnormal times. According to a fault pattern of the FET, the turn-on/turn-off state of each FET in the two switching circuits 110 is determined. In addition, the turn-on/turn-off state of each FET in a faulty inverter is also determined.

First, a specific example of a control method at the normal times of the electric power conversion device 100 is described. As described above, the normal times refers to a state in which each FET of the first and second inverters 120 and 130 is not faulty and each FET in the two switching circuits 110 is not faulty.

At the normal times, the control circuit 300 turns on all the FETs 111, 112, 113 and 114 of the two switching circuits 110. For this reason, the power source 101 and the first inverter 120 are electrically connected, and the power source 101 and the second inverter 130 are also electrically connected. In addition, the first inverter 120 is electrically connected to the GND, and the second inverter 130 is also electrically connected to the GND. In this connection state, the control circuit 300 performs three-phase energization control using both the first and second inverters 120 and 130 and thereby drives the motor 200. Specifically, the control circuit 300 performs three-phase energization control by controlling a switching of the FET of the first inverter 120 and the FET of the second inverter 130 in reverse phase (phase difference=180°). For example, focusing on the H bridge including FETs 121L, 121H, 131L, and 131H, when the FET 121L is turned on, the FET 131L is turned off, and when the FET 121L is turned off, the FET 131L is turned on. Similarly, when the FET 121H is turned on, the FET 131H is turned off, and when the FET 121H is turned off, the FET 131H is turned on. The current outputted from the power source 101 flows to the GND through the high-side switching element, the winding, and the low-side switching element.

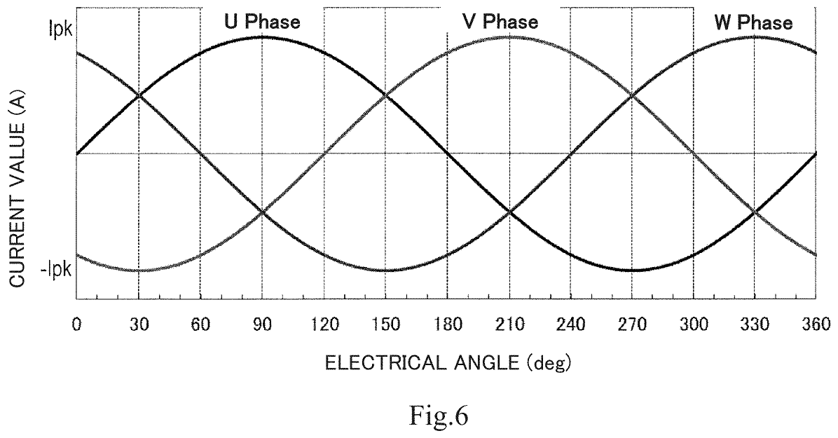

FIG. 6 illustrates a current waveform (a sine wave) obtained by plotting values of the currents flowing through the U-phase, the V-phase, and the W-phase windings of the motor 200 when the electric power conversion device 100 is controlled according to the three-phase energization control. A horizontal axis represents an electric angle (deg) of a motor, and a vertical axis represents a current value (A). In the current waveform of FIG. 6, the current value is plotted for each electrical angle of 30°. Iₚₖ represents a maximum current value (peak current value) of each phase.

Table 1 shows the values of the currents flowing through terminals of each inverter for each electric angle in the sine wave of FIG. 6. Specifically, Table 1 shows the values of the currents flowing in the terminals U_L, V_L, and W_L of the first inverter 120 (bridge circuit L) at every 30° of the electrical angle, and the values of the currents flowing in the terminals U_R, V_R, and W_R of the second inverter 130 (bridge circuit R) at every 30° of the electrical angle. Here, for the bridge circuit L, a direction of the current flowing from the terminal of the bridge circuit L to the terminal of the bridge circuit R is defined as a positive direction. The current direction shown in FIG. 6 follows this definition. Also, for the bridge circuit R, a direction of the current flowing from the terminal of the bridge circuit R to the terminal of the bridge circuit L is defined as a positive direction. Therefore, the phase difference between the current of the bridge circuit L and the current of the bridge circuit R becomes 180°. In Table 1, magnitude of a current value I₁ is [(3)^{1/2}/2]*Iₚₖ, and magnitude of a current value I₂ is Iₚₖ/2.

TABLE 1

| | | ELECTRICAL ANGLE [deg] | | | | | | | | | | | |
|---|---|---|---|---|---|---|---|---|---|---|---|---|---|
| OPERATION AT THE | | 0 | | | | | | | | | | | |
| NORMAL TIMES | | (360) | 30 | 60 | 90 | 120 | 150 | 180 | 210 | 240 | 270 | 300 | 330 |
| BRIDGE | U_L | 0 | I₂ | I₁ | Ipk | I₁ | I₂ | 0 | −I₂ | −I₁ | −Ipk | −I₁ | −I₂ |
| CIRCUIT | PHASE | | | | | | | | | | | | |
| L | V_L | −I₁ | −Ipk | −I₁ | −I₂ | 0 | I₂ | I₁ | Ipk | I₁ | I₂ | 0 | −I₂ |
| | PHASE | | | | | | | | | | | | |
| | W_L | I₁ | I₂ | 0 | −I₂ | −I₁ | −Ipk | −I₁ | −I₂ | 0 | I₂ | I₁ | Ipk |
| | PHASE | | | | | | | | | | | | |
| BRIDGE | U_R | 0 | −I₂ | −I₁ | −Ipk | −I₁ | −I₂ | 0 | I₂ | I₁ | Ipk | I₁ | I₂ |
| CIRCUIT | PHASE | | | | | | | | | | | | |
| R | V_R | I₁ | Ipk | I₁ | I₂ | 0 | −I₂ | −I₁ | −Ipk | −I₁ | −I₂ | 0 | I₂ |
| | PHASE | | | | | | | | | | | | |
| | W_R | −I₁ | −I₂ | 0 | I₂ | I₁ | Ipk | I₁ | I₂ | 0 | −I₂ | −I₁ | −Ipk |
| | PHASE | | | | | | | | | | | | |

No current flows in the U-phase winding M1 at the electric angle of 0°. A current of magnitude I₁ flows from the bridge circuit R to the bridge circuit L in the V-phase winding M2, and a current of magnitude I₁ flows from the bridge circuit L to the bridge circuit R in the W-phase winding M3.

At the electrical angle of 30°, a current of magnitude I₂ flows from the bridge circuit L to the bridge circuit R in the U-phase winding M1, a current of magnitude Iₚₖ flows from the bridge circuit R to the bridge circuit L in the V-phase winding M2, and a current of magnitude I₂ flows from the bridge circuit L to the bridge circuit R in the W-phase winding M3.

At the electrical angle of 60°, a current of magnitude I₁ flows from the bridge circuit L to the bridge circuit R in the U-phase winding M1, and a current of magnitude I₁ flows from the bridge circuit R to the bridge circuit L in the V-phase winding M2. No current flows through the W-phase winding M3.

At the electrical angle of 90°, a current of magnitude Iₚₖ flows from the bridge circuit L to the bridge circuit R in the U-phase winding M1, a current of magnitude I₂ flows from the bridge circuit R to the bridge circuit L in the V-phase winding M2, and a current of magnitude I₂ flows from the bridge circuit R to the bridge circuit L in the W-phase winding M3.

At the electrical angle of 120°, a current of magnitude I₁ flows from the bridge circuit L to the bridge circuit R in the U-phase winding M1, and a current of magnitude I₁ flows from the bridge circuit R to the bridge circuit L in the W-phase winding M3. No current flows through the V-phase winding M2.

At the electrical angle of 150°, a current of magnitude I₂ flows from the bridge circuit L to the bridge circuit R in the U-phase winding M1, a current of magnitude I₂ flows from the bridge circuit L to the bridge circuit R in the V-phase winding M2, and a current of magnitude Iₚₖ flows from the bridge circuit R to the bridge circuit L in the W-phase winding M3.

At the electrical angle of 180°, no current flows through the U-phase winding M1. A current of magnitude I₁ flows from the bridge circuit L to the bridge circuit R in the V-phase winding M2, and a current of magnitude I₁ flows from the bridge circuit R to the bridge circuit L in the W-phase winding M3.

At the electrical angle of 210°, a current of magnitude I₂ flows from the bridge circuit R to the bridge circuit L in the U-phase winding M1, a current of magnitude Iₚₖ flows from the bridge circuit L to the bridge circuit R in the V-phase winding M2, and a current of magnitude I₂ flows from the bridge circuit R to the bridge circuit L in the W-phase winding M3.

At the electrical angle of 240°, a current of magnitude flows from the bridge circuit R to the bridge circuit L in the U-phase winding M1, and a current of magnitude I₁ flows from the bridge circuit L to the bridge circuit R in the V-phase winding M2. No current flows through the W-phase winding M3.

At the electrical angle of 270°, a current of magnitude Iₚₖ flows from the bridge circuit R to the bridge circuit L in the U-phase winding M1, a current of magnitude I₂ flows from the bridge circuit L to the bridge circuit R in the V-phase winding M2, and a current of magnitude I₂ flows from the bridge circuit L to the bridge circuit R in the W-phase winding M3.

At the electrical angle of 300°, a current of magnitude flows from the bridge circuit R to the bridge circuit L in the U-phase winding M1, and a current of magnitude I₁ flows from the bridge circuit L to the bridge circuit R in the W-phase winding M3. No current flows through the V-phase winding M2.

At the electrical angle of 330°, a current of magnitude I₂ flows from the bridge circuit R to the bridge circuit L in the U-phase winding M1, a current of magnitude I₂ flows from the bridge circuit R to the bridge circuit L in the V-phase winding M2, and a current of magnitude Iₚₖ flows from the bridge circuit L to the bridge circuit R in the W-phase winding M3.

According to the three-phase energization control, the sum of the currents flowing through the three-phase windings in consideration of the current direction always becomes “0 (zero)” for each electrical angle. For example, the control circuit 300 controls the switching operation of each FET of the bridge circuits L and R using PWM control such that the current waveform shown in FIG. 6 is obtained.

As described above, the term “fault” mainly means that a fault has occurred in the FET. The fault of the FET is largely classified into “open-fault” and “short-fault”. The term “open-fault” refers to a fault in which the region between a source and a drain of the FET is open (in other words, rds (a resistance between the source and the drain) becomes high impedance), and the term “short-fault” refers to a fault in which the source-drain of the FET is short-circuited.

Referring to FIG. 1 again, during operation of the electric power conversion device 100, it is generally considered that a random fault in which one FET among the plurality of FETs randomly becomes faulty has occurred. The present disclosure is mainly directed to a method of controlling the electric power conversion device 100 when a random fault occurs. However, the present disclosure is also directed to the method for controlling the electric power conversion device 100 when the plurality of FETs become successively faulty. The term “successive faults” means, for example, that faults occur simultaneously in the high-side switching element and the low-side switching element of one leg.

If the electric power conversion device 100 is used for a long period of time, it is likely that a random fault may occur. Also, the random fault is different from a manufacturing fault that may occur at the time of manufacturing. If even one FET among the plurality of FETs in the two inverters becomes faulty, the three-phase energization control at the normal times is no longer possible.

As one example of the fault detection, the driving circuit 350 monitors a voltage between the source and the drain of each FET, and compares a voltage between the source and the drain, and a predetermined threshold voltage Vds and thereby detects the fault of the FET. For example, the threshold voltage is set in the driving circuit 350 by data communication with an external IC (not shown) and external attachment components. The driving circuit 350 is connected to a port of the microcontroller 340 and notifies the microcontroller 340 of a fault detection signal. For example, the driving circuit 350 asserts the fault detection signal when detecting the fault of the FET. When receiving the asserted fault detection signal, the microcontroller 340 reads internal data of the driving circuit 350, and determines which FET among the plurality of FETs has been faulty.

As another example of fault detection, the microcontroller 340 may detect the fault in the FET on the basis of the difference between an actual current value and a target current value of the motor. However, the fault detection is not limited to these methods, and a variety of methods related to the fault detection may be employed.

When the fault detection signal is asserted, the microcontroller 340 switches control for the electric power conversion device 100 from control at the normal times to control at the abnormal times. For example, the timing at which control is switched from control at the normal times to control at the abnormal times is about 10 msec. to 30 msec. after the fault detection signal is asserted.

There are various fault patterns for the fault of the electric power conversion device 100. Hereinafter, the fault pattern is classified for each case, and control of the electric power conversion device 100 at the abnormal times will be described in details for each pattern. In the example embodiment of the present disclosure, the first inverter 120 among the two inverters is treated as a faulty inverter, and the second inverter 130 is treated as a normal inverter.

Control performed at the abnormal times in which the three high-side switching elements in the bridge circuit of the first inverter 120 include an open-faulty switching element is described.

It is assumed that the FET 121H among the high-side switching elements FETs 121H, 122H, and 123H of the first inverter 120 is open-faulty. In addition, even when the FET 122H or 123H is open-faulty, the electric power conversion device 100 may be controlled by a control method described below.

When the FET 121H is open-faulty, the control circuit 300 brings the FETs 111, 112, 113, and 114 of the two switching circuits 110 and the FETs 122H, 123H, 121L, 122L, and 123L of the first inverter 120 into a first state. In the first state, the FETs 111 and 113 of the two switching circuits 110 are turned off and the FETs 112 and 114 are turned on. Further, the FETs 122H and 123H (high-side switching elements different from the faulty FET 121H) other than the faulty FET 121H of the first inverter 120 are turned off, and the FETs 121L, 122L, and 123L are turned on.

In the first state, the first inverter 120 is electrically disconnected from the power source 101 and the GND, and second inverter 130 is electrically connected to the power source 101 and the GND. In other words, when the first inverter 120 is at the abnormal times, the FET 113 blocks the connection between the power source 101 and the first inverter 120, and the FET 111 blocks a connection between the first inverter 120 and the GND. In addition, by turning on all the three low-side switching elements, the node N1 of the low-side side functions as a neutral point of each winding. In the present specification, the feature that any node functions as a neutral point is expressed as “the neutral point is configured”. The electric power conversion device 100 drives the motor 200 using the neutral point configured in the low-side side of the first inverter 120, and the second inverter 130.

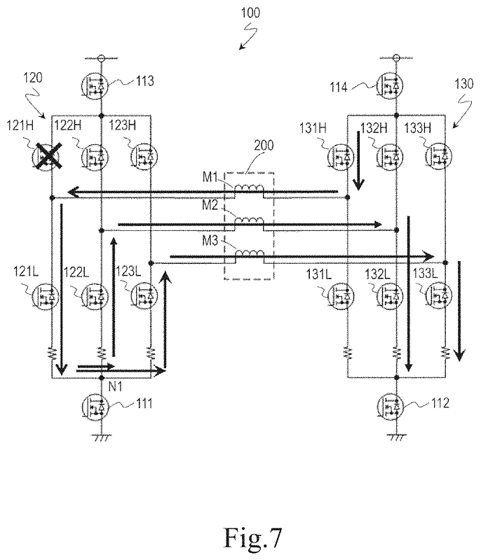

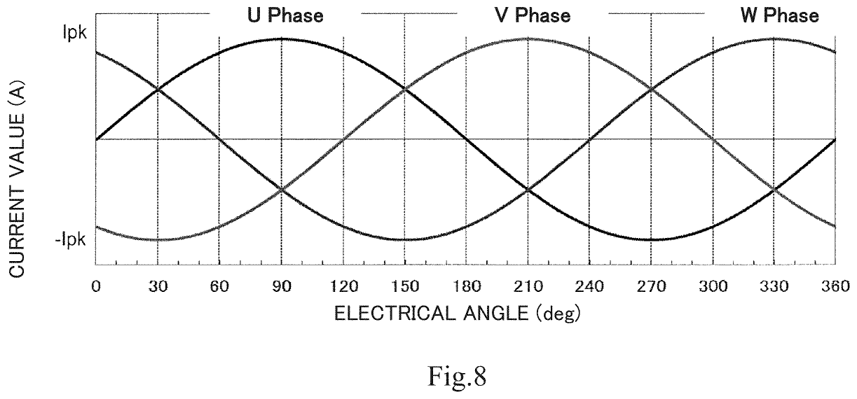

FIG. 7 schematically shows a flow of the current in the electric power conversion device 100 when the FETs of the two switching circuits 110 and the first inverter 120 are in the first state. FIG. 8 illustrates current waveforms obtained by plotting current values flowing through each of the U-phase, V-phase, and W-phase windings of the motor 200 when the electric power conversion device 100 is controlled in the first state. FIG. 7 shows, as an example, a flow of the current at a motor electrical angle of 270°. Each of straight arrows represents the current flowing from the power source 101 to the motor 200.

In a state shown in FIG. 7, in the second inverter 130, the FETs 131H, 132L, and 133L are turned on, and the FETs 131L, 132H, and 133H are turned off. The current flowing through the FET 131H of the second inverter 130 flows to the neutral point through the winding M1 and the FET 121L of the first inverter 120. Some of this current flows to the winding M2 through the FET 122L, and the remaining current flows to the winding M3 through the FET 123L. The current flowing through the windings M2 and M3 flows to the GND through the FET 112 of the second inverter 130 side. In a free-wheeling diode (also referred to as a “regenerative diode”) of the FET 131L, furthermore, a regenerative current flows towards the winding M1 of the motor 200. As will be described later with reference to FIG. 11, a parasitic diode 140 is provided inside each of the FETs 121L, 122L, 123L, 121H, 122H, 123H, 131L, 132L, 133L, 131H, 132H, and 133H. In each FET, the parasitic diode 140 is disposed such that a forward current flows in a direction of the power source 101. In the example embodiment of the present disclosure, this parasitic diode 140 is employed as the free-wheeling diode.

Table 2 illustrates the value of the current flowing to the terminal of the second inverter 130 for each electric angle in the current waveform of FIG. 8. Specifically, Table 2 illustrates the value of the current flowing to the terminals U_R, V_R, and W_R of the second inverter 130 (the bridge circuit R) for every electric angle of 30°. The definition of the current direction is as described above. Also, according to the definition of the current direction, positive and negative signs of the current value shown in FIG. 8 are in a reverse relationship (the phase difference of 180°) in which the signs of the current value shown in FIG. 8 are opposite to the signs of the current value shown in Table 2.

TABLE 2

| | | ELECTRICAL ANGLE [deg] | | | | | | | | | | | |
|---|---|---|---|---|---|---|---|---|---|---|---|---|---|
| OPERATION AT THE | | 0 | | | | | | | | | | | |
| NORMAL TIMES | | (360) | 30 | 60 | 90 | 120 | 150 | 180 | 210 | 240 | 270 | 300 | 330 |
| BRIDGE | U_R | 0 | −I₂ | −I₁ | −Ipk | −I₁ | −I₂ | 0 | I₂ | I₁ | Ipk | I₁ | I₂ |
| CIRCUIT | PHASE | | | | | | | | | | | | |
| R | V_R | I₁ | Ipk | I₁ | I₂ | 0 | −I₂ | −I₁ | −Ipk | −I₁ | −I₂ | 0 | I₂ |
| | PHASE | | | | | | | | | | | | |
| | W_R | −I₁ | −I₂ | 0 | I₂ | I₁ | Ipk | I₁ | I₂ | 0 | −I₂ | −I₁ | −Ipk |
| | PHASE | | | | | | | | | | | | |

For example, at the electrical angle of 30°, a current of magnitude I₂ flows from the bridge circuit L to the bridge circuit R in the U-phase winding M1, a current of magnitude Iₚₖ flows from the bridge circuit R to the bridge circuit L in the V-phase winding M2, and a current of magnitude I₂ flows from the bridge circuit L to the bridge circuit R in the W-phase winding M3. At the electrical angle of 60°, a current of magnitude I₁ flows from the bridge circuit L to the bridge circuit R in the U-phase winding M1, and a current of magnitude I₁ flows from the bridge circuit R to the bridge circuit L in the V-phase winding M2. No current flows through the W-phase winding M3. The sum of the current flowing into the neutral point and the current flowing out from the neutral point always becomes “0” for each electric angle. For example, the control circuit 300 controls the switching operation of each FET of the bridge circuit R using PWM control such that the current waveform shown in FIG. 8 is obtained.

As shown in Tables 1 and 2, it is confirmed that the motor current flowing in the motor 200 between control at the normal times and control at the abnormal times is not changed for each electric angle. For this reason, an assist torque of the motor is not reduced in control at the abnormal times as compared with control at the normal times.

Since the power source 101 and the first inverter 120 are not electrically connected, no current flows from the power source 101 to the first inverter 120. Further, since the first inverter 120 and the GND are not electrically connected, the current flowing through the neutral point does not flow to the GND. For this reason, power loss may be suppressed, and appropriate current control is enabled by forming a closed loop of a driving current.

When the high-side switching element (FET 121H) is open-faulty, the state of the FETs of the two switching circuits 110 and the first inverter 120 is not limited to the first state. For example, the control circuit 300 may bring the FETs of the switching circuits 110 and the first inverter 120 into a second state. In the second state, the FET 113 of the two switching circuits 110 is turned on, the FET 111 is turned off, and the FETs 112 and 114 are turned on. Further, the FETs 122H and 123H other than the faulty FET 121H of the first inverter 120 are turned off, and the FETs 121L, 122L and 123L are turned on. The difference between the first state and the second state is whether the FET 113 is turned on. The reason why the FET 113 may be turned on is that when the FET 121H is open-faulty, all the high-side switching elements become to be in an open state by controlling the FETs 122H and 123H into the turn-off state, and no current flows from the power source 101 to the first inverter 120 even when the FET 113 is turned on. As described above, the FET 113 may be in a turn-on state or in a turn-off state at the time of an open-fault.

Control performed at the abnormal times in which the three high-side switching elements in the bridge circuit of the first inverter 120 include a short-faulty switching element is described.

It is assumed that the FET 121H among the high-side switching elements FETs 121H, 122H, and 123H of the first inverter 120 is short-faulty. In addition, even when the FET 122H or 123H is short-faulty, the electric power conversion device 100 may be controlled by a control method described below.

When the FET 121H is short-faulty, the control circuit 300 brings the FETs 111, 112, 113, and 114 of the two switching circuits 110 and the FETs 122H, 123H, 121L, 122L, and 123L of the first inverter 120 into the first state. In addition, in the case of a short-fault, when the FET 113 is turned on, a current flows from the power source 101 to the short-faulty FET 121H such that a control in the second state is prohibited.

As in the case of the open-fault, by turning on all three low-side switching elements, the neutral point of each winding is configured on the node N1 of the low-side side. The electric power conversion device 100 drives the motor 200 using the neutral point configured at the low-side side of the first inverter 120, the second inverter 130. The control circuit 300 controls switching operation of each FET of the bridge circuit R using PWM control such that the current waveform shown in FIG. 8 is obtained, for example. For example, in the first state at the time of the short-fault, a flow of current flowing in the electric power conversion device 100 when the electrical angle is 270° is as shown in FIG. 7, and a value of the current flowing at each winding for each motor electrical angle is as shown in Table 2.

In addition, when the FET 121H is short-faulty, for example, in a first state of each FET as shown in FIG. 7, a regenerative current flows in the FET 121H through the parasitic diode of the FET 122H at the motor electrical angle of 0°˜120° in Table 2, and a regenerative current flows in the FET 121H through the parasitic diode of the FET 123H at the motor electrical angle of 60°˜180° in Table 2. In this way, when a short-fault occurs, the, current can be distributed through the FET 121H when the motor electrical angle is in a certain range.

According to this control, since the power source 101 and the first inverter 120 are electrically disconnected, no current flows from the power source 101 to the first inverter 120. In addition, the first inverter 120 and the GND are electrically disconnected, the current flowing in the neutral point does not flow to the GND.

Control performed at the abnormal times in which the three low-side switching elements in the bridge circuit of the first inverter 120 include an open-faulty switching element is described.

It is assumed that the FET 121L among the low-side switching elements FETs 121L, 122L, and 123L of the first inverter 120 is open-faulty. In addition, even when the FET 122L or 123L is open-faulty, the electric power conversion device 100 may be controlled by a control method described below.

When the FET 121L is open-faulty, the control circuit 300 brings the FETs 111, 112, 113, and 114 of the two switching circuits 110 and the FETs 121H, 122H, 123H, 122L and 123L of the first inverter 120 into a third state. In the third state, the FETs 111 and 113 of the two switching circuits 110 are turned off, and the FETs 112 and 114 are turned on. Further, the FETs 122L and 123L (low-side switching elements different from the faulty FET 121L) other than the faulty FET 121L of the first inverter 120 are turned off, and the FETs 121H, 122H, and 123H are turned on.

In the third state, the first inverter 120 is electrically disconnected from the power source 101 and the GND, and the second inverter 130 is electrically connected to the power source 101 and the GND. Further, by turning on all three high-side switching elements of the first inverter 120, the neutral point of each winding is configured on the node N3 of the high-side side.

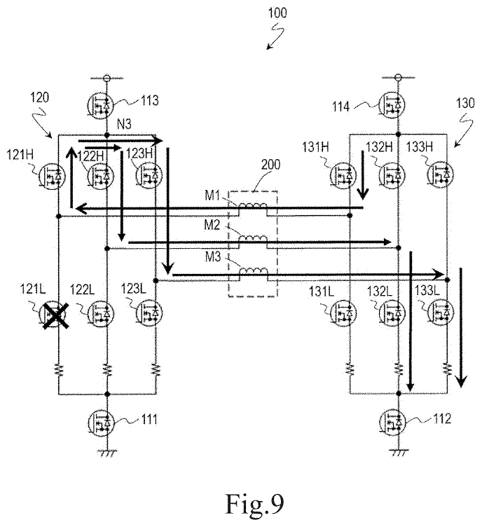

FIG. 9 schematically shows a flow of the current in the electric power conversion device 100 when the FETs of two switching circuits 110 and the first inverter 120 are in the third state. FIG. 9 shows a flow of the current at the motor electrical angle of 270°, for example. Each of the straight arrows represents the current flowing from the power source 101 to the motor 200.

In the state shown in FIG. 9, in the second inverter 130, the FETs 131H, 132L, and 133L are in a turn-on state, and the FETs 131L, 132H, and 133H are in a turn-off state. The current flowing in the FET 131H of the second inverter 130 flows to the neutral point through the winding M1 and the FET 121H of the first inverter 120. Some of this current flows to the winding M2 through the FET 122H, and the remaining current flows to the winding M3 through the FET 123H. The current flowing in the windings M2 and M3 flows to the GND through the FET 112 of the second inverter 130 side. In addition, in the parasitic diode of the FET 131L, a regenerative current flows towards the winding M1 of the motor 200. For example, the value of current flowing in each winding for each motor electrical angle is as shown in Table 2.

The electric power conversion device 100 drives the motor 200 using the neutral point that is configured on the high-side side of the first inverter 120, and the second inverter 130. The control circuit 300 controls switching operation of each FET of the bridge circuit R by PWM control such that the current waveform shown in FIG. 8 is obtained, for example.

According to this control, since the power source 101 and the first inverter 120 are not electrically connected, no current flows from the power source 101 to the neutral point of the first inverter 120. Further, since the first inverter 120 and the GND are not electrically connected, the current does not flow from the first inverter 120 to the GND.

When the low-side switching element FET 121L is open-faulty, the state of the FETs of the two switching circuits 110 and the first inverter 120 is not limited to the third state. For example, the control circuit 300 may bring the FETs of the switching circuits 110 and the first inverter 120 into a fourth state. In the fourth state, the FET 113 of the two switching circuits 110 is turned off, the FET 111 is turned on, and the FETs 112 and 114 are turned on. Further, the FETs 122L and 123L other than the faulty FET 121L of the first inverter 120 are turned off, and the FETs 121H, 122H, and 123H are turned on. The difference between the third state and the fourth state is whether the FET 111 is turned on. The reason why the FET 111 may be turned on is that when the FET 121L is open-faulty, all the low-side switching elements become to be in an open state by controlling the FETs 122L and 123L into the turn-off state, and no current flows to the GND even when the FET 111 is turned on. As described above, the FET 111 may be in a turn-on state or in a turn-off state at the time of an open-fault.

Control performed at the abnormal times in which the three low-side switching elements in the bridge circuit of the first inverter 120 include a short-faulty switching element is described.

It is assumed that the FET 121L among the low-side switching elements FETs 121L, 122L, and 123L of the first inverter 120 is short-faulty. In addition, even when the FET 122L or 123L is short-faulty, the electric power conversion device 100 may be controlled by a control method described below.

When the FET 121L is short-faulty, the control circuit 300 brings the FETs 111, 112, 113, and 114 of the two switching circuits 110 and the FETs 121H, 122H, 123H, 122L, and 123L of the first inverter 120 into the third state similar to the case when the open-fault occurs. In the case of the short fault, when the FET 111 is turned on, a current flows from the shorted FET 121L to the GND such that the control in the fourth state is prohibited.

In the state shown in FIG. 9, in the second inverter 130, the FETs 131H, 132L, and 133L are in a turn-on state, and the FETs 131L, 132H, and 133H are in a turn-off state. The current flowing in the FET 131H of the second inverter 130 flows to the neutral point through the winding M1 and the FET 121H of the first inverter 120. Some of this current flows to the winding M2 through the FET 122H, and the remaining current flows to the winding M3 through the FET 123H. The current flowing in the windings M2 and M3 flows to the GND through the FET 112 of the second inverter 130 side. In addition, in the parasitic diode of the FET 131L, a regenerative current flows towards the winding M1 of the motor 200. In contrast with the case when the open-fault occurs, when the short-fault occurs, the current flows from the shorted FET 121L to the node N1 of the low-side side. Some of the current flows to the winding M2 through the parasitic diode ODE of the FET 122L, and the remaining current flows to the winding M3 through the parasitic diode of the FET 123L. The current flowing to the windings M2 and M3 flows to the GND through the FET 112.

For example, the value of current flowing in each winding for each motor electrical angle is as shown in Table 2.

The electric power conversion device 100 drives the motor 200 using the neutral point that is configured on the high-side side of the first inverter 120, and the second inverter 130. The control circuit 300 controls switching operation of each FET of the bridge circuit R by PWM control such that the current waveform shown in FIG. 8 is obtained, for example.

According to this control, since the power source 101 and the first inverter 120 are electrically disconnected, no current flows from the power source 101 to the neutral point of the first inverter 120. In addition, the first inverter 120 and the GND are electrically disconnected, no current flows from the first inverter 120 to the GND.

In the above description of the example embodiment of the present disclosure, the first inverter 120 among the two inverters is treated as a faulty inverter, and the second inverter 130 is treated as a normal inverter. Even when the second inverter 130 is a faulty inverter and the first inverter 120 is a normal inverter, the control at the abnormal times may be performed as described above. In this case, the control of the first inverter 120, the second inverter 130, and the switching circuit 110 is performed in the manner opposite to the above control. That is, the neutral point is configured in the second inverter 130, and the motor 200 may be driven using the neutral point and the first inverter 120.

Next, an operation for diagnosing whether a fault of the FET occurs in the electric power conversion device 100 driving the motor 200 using the two inverters 120 and 130 of the example embodiment of the present disclosure will be described. In the fault diagnosis of the example embodiment of the present disclosure, when a fault of the FET occurs, it is possible to specify which FET among the plurality of FETs has been faulty.

In the fault diagnosis of the example embodiment of the present disclosure, a diagnosis is performed in a state where the above-described neutral point is configured. The fault diagnosis may be performed, for example, by regularly configuring the neutral points during the above-described control operation at the normal times. Further, for example, even when the fault has already occurred and the motor 200 is being driven by configuring the neutral point, the fault diagnosis may be performed.

In the fault diagnosis of the example embodiment of the present disclosure, an open-fault of the FET is detected. As described above, the open-fault refers to a fault in which the region between the source and the drain of the FET are open (in other words, the resistance between the source and the drain is always in a high impedance state).

First, operation of configuring the neutral point on the node N1 of the low-side of the first inverter 120 and performing the fault diagnosis is described.

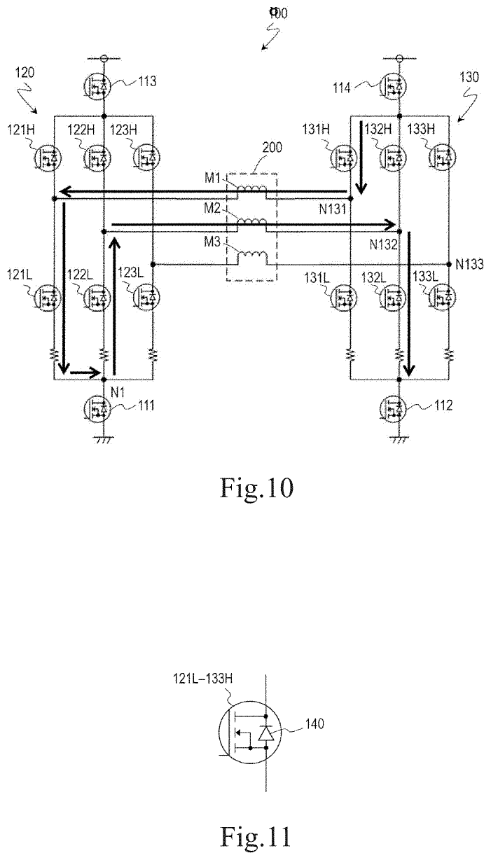

FIG. 10 is a view illustrating an example of an operation for configuring the neutral point and performing the fault diagnosis.

The control circuit 300 turns off the FETs 111 and 113 and turns on the FETs 112 and 114. In addition, the control circuit 300 turns off the FETs 121H, 122H, and 123H, turns on the FETs 121L, 122L, and 123L, and configures the neutral point on the node N1.

In parallel with the operation for configuring the neutral point, the control circuit 300 turns on the FETs 131H and 132L and turns off the FETs 131L, 132H, 133L, and 133H. For this reason, a conductive path in which the FET 131H of the high-side of the second inverter 130, the U-phase winding M1, the neutral point (node N1), the V-phase winding M2, and the FET 132L of the low-side of the second inverter 130 are connected is configured. A voltage from the power source 101 is applied to this conductive path such that the current flows in the conductive path. Each of straight arrows represents the current flowing in the conductive path.

FIG. 11 is a view illustrating the FETs included in the first and second inverters 120 and 130. The parasitic diode 140 is provided inside each of the FETs 121L, 122L, 123L, 121H, 122H, 123H, 131L, 132L, 133L, 131H, 132H, and 133H. In each FET, the parasitic diode 140 is disposed so that the forward current flows towards the power source 101. That is, the parasitic diode 140 is disposed so that the cathode faces the power source 101 and the anode faces the GND. In the example embodiment of the present disclosure, this parasitic diode 140 is used as a free-wheeling diode. In addition, an element configuration in which the free-wheeling diodes are connected in parallel to the FET may also be employed in the example embodiment of the present disclosure.

Referring to FIG. 10, in the example embodiment of the present disclosure, it is diagnosed whether the switching element in which the current flowing in the above conductive path becomes a reverse current in the free-wheeling diode 140 is faulty. In the example shown in FIG. 10, the current flowing in the conductive path becomes the reverse current in the free-wheeling diode 140 of the FETs 121L, 131H, and 132L. That is, it is diagnosed whether the FETs 121L, 131H, and 132L are faulty.

The control circuit 300 diagnoses whether the fault occurs using at least two of U-phase voltage value, V-phase voltage value, and W-phase voltage value when a voltage is applied to the above conductive path. The U-phase voltage value is, for example, voltage value of a node N131 to which the FET 131H and the FET 131L are connected. The voltage value of the node N131 is, for example, a potential difference between the node N131 and the GND. A voltage of the node N131 may be the same as a voltage of the terminal U_R (FIG. 1). The V-phase voltage value is, for example, voltage value of a node N132 to which the FET 132H and the FET 132L are connected. The voltage value of the node N132 is, for example, a potential difference between the node N132 and the GND. A voltage of the node N132 may be the same as a voltage of the terminal V_R (FIG. 1). The W-phase voltage value is, for example, voltage value of a node N133 to which the FET 133H and the FET 133L are connected. The voltage value of the node N133 is, for example, a potential difference between the node N133 and the GND. A voltage of the node N133 may be the same as a voltage of the terminal W_R (FIG. 1). The voltage detection circuit 380 (FIG. 5) detects the voltage value of each of the U phase, V phase, and W phase, and outputs the voltage value to the microcontroller 340.

First, voltage values when all the FETs 121L, 131H, and 132L are normal will be described. When all the FETs 121L, 131H, and 132L are normal, the voltage of the node N131 becomes close to an output voltage of the power source 101. Also, the voltage of the node N132 becomes a value between the output voltage of the power source 101 and the GND voltage. For example, the voltage of the node N132 becomes slightly closer to the GND voltage than the output voltage of the power source 101. Hereinafter, such value which is close to the output voltage of the power source 101 is expressed as the voltage is “high”. In addition, the value between the output voltage of the power source 101 and the GND voltage is expressed as the voltage is “medium”.

When the voltage of the node N131 is “high” and the voltage of the node N132 is “medium”, the microcontroller 340 judges that all the FETs 121L, 131H, and 132L are normal.

Next, a voltage value when the FET 131H is open-faulty is described. When the FET 131H is open-faulty, a power source voltage is not applied to the node N131. For this reason, the voltages of the nodes N131 and N132 become value close to the GND voltage. Hereinafter, such a value close to the GND voltage is expressed as the voltage is “low”. Further, the above-mentioned expression the voltage is “medium” indicates that the voltage has a value between “high” voltage and “low” voltage.

When all the voltages of the nodes N131 and N132 are “low”, the microcontroller 340 judges that the FET 131H is open-faulty.

Next, a voltage value when the FET 121L is open-faulty is described. When the FET 121L is open-faulty, the voltage of the node N131 becomes “high” and the voltage of the node N132 becomes “low”.

When the voltage of the node N131 is “high” and the voltage of the node N132 is “low”, the microcontroller 340 judges that the FET 121L is open-faulty.

Next, a voltage value when the FET 132L is open-faulty is described. In this case, the node N132 is not connected to the GND. For this reason, all the voltages of the nodes N131 and N132 become “high”.

When all the voltages of the nodes N131 and N132 are “high”, the microcontroller 340 judges that the FET 132L is open-faulty.

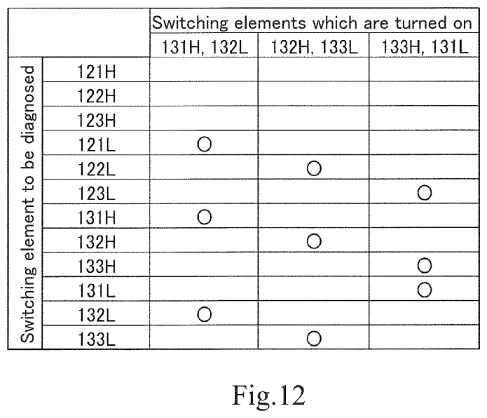

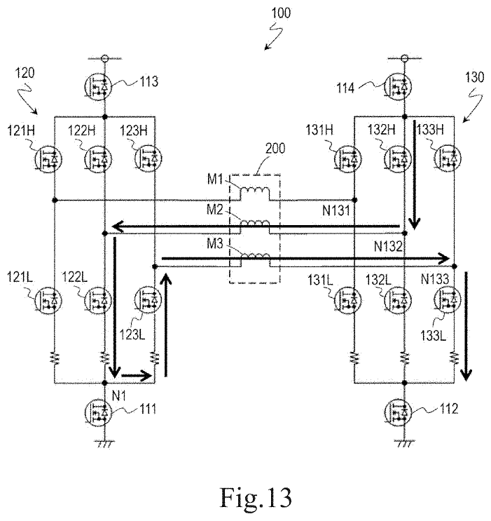

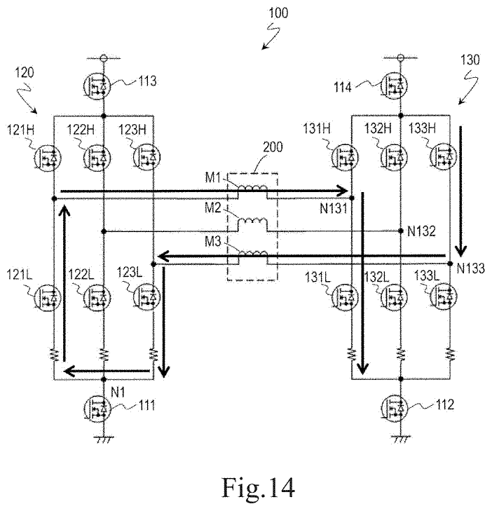

FIG. 12 is a view illustrating a relationship between the switching element which is turned on and the switching element to be diagnosed, in the second inverter 130 when the neutral point is configured on the low-side. In the table shown in FIG. 12, the switching elements which can be diagnosed with respect to the switching element which is turned on are indicated by white circles. In the example shown in FIG. 10, the FETs 131H and 132L are in a turned-on state, and it is possible to diagnose whether the FETs 121L, 131H, and 132L are faulty. Hereinafter, the fault diagnosis when the FETs 132H and 133L are in a turned-on state is described using FIG. 13. In addition, the fault diagnosis when the FETs 133H and 131L are in a turned-on state is described using FIG. 14.

FIG. 13 is a view explaining the fault diagnosis when the FETs 132H and 133L are turned on. Similar to the example in FIG. 10, the control circuit 300 configures the neutral point on the node N1.

In parallel with the operation for configuring the neutral point, the control circuit 300 turns on the FETs 132H and 133L and turns off the FETs 131L, 131H, 132L, and 133H. For this reason, a conductive path in which the FET 132H of the high-side of the second inverter 130, the V-phase winding M2, the neutral point (node N1), the W-phase winding M3, and the FET 133L of the low-side of the second inverter 130 are connected is configured. A voltage from the power source 101 is applied to this conductive path so that the current flows in the conductive path. Each of straight arrows represents the current flowing in the conductive path.

In the example shown in FIG. 13, the current flowing in the conductive path becomes the reverse current in the free-wheeling diode 140 of the FETs 132H, 122L, and 133L. In the example shown in FIG. 13, it is diagnosed whether the FETs 132H, 122L, and 133L are faulty.

Similar to the method described with reference to FIG. 10, the microcontroller 340 determines whether a voltage of each of the nodes N132 and N133 is any one of “high”, “medium”, or “low” and thereby performs the fault diagnosis.

When the voltage of the node N132 is “high” and the voltage of the node N133 is “medium”, the microcontroller 340 judges that all the FETs 132H, 122L, and 133L are normal.

When all the voltages of the nodes N132 and N133 are “low”, the microcontroller 340 judges that the FET 132H is open-faulty.

When the voltage of the node N132 is “high” and the voltage of the node N133 is “low”, the microcontroller 340 judges that the FET 122L is open-faulty.

When all the voltages of the nodes N132 and N133 are “high”, the microcontroller 340 judges that the FET 133L is open-faulty.

FIG. 14 is a view for explaining the fault diagnosis when the FETs 133H and 131L are turned on. Similar to the examples of FIGS. 10 and 13, the control circuit 300 configures the neutral point on the node N1.

In parallel with the operation for configuring the neutral point, the control circuit 300 turns on the FETs 133H and 131L and turns off the FETs 131H, 132L, 132H, and 133L. For this reason, a conductive path in which the FET 133H of the high-side of the second inverter 130, the W-phase winding M3, the neutral point (node N1), the U-phase winding M1, and the FET 131L of the low-side of the second inverter 130 are connected is configured. A voltage from the power source 101 is applied to this conductive path such that the current flows in the conductive path. Each of straight arrows represents the current flowing in the conductive path.

In the example shown in FIG. 14, the current flowing in the conductive path becomes the reverse current in the free-wheeling diode 140 of the FETs 133H, 123L, and 131L. In the example shown in FIG. 14, it is diagnosed whether the FETs 133H, 123L and 131L are faulty.

Similar to the method described with reference to FIGS. 10 and 13, the microcontroller 340 determines whether a voltage of each of the nodes N133 and N131 is any one of “high”, “medium”, and “low” and then performs the fault diagnosis.

When the voltage of the node N133 is “high” and the voltage of the node N131 is “medium”, the microcontroller 340 judges that all the FETs 133H, 123L, and 131L are normal.

When all the voltages of the nodes N133 and N131 are “low”, the microcontroller 340 judges that the FET 133H is open-faulty.

When the voltage of the node N133 is “high” and the voltage of the node N131 is “low”, the microcontroller 340 judges that the FET 123L is open-faulty.

When all the voltages of the nodes N133 and N131 are “high”, the microcontroller 340 judges that the FET 131L is open-faulty.

As described above, according to the example embodiment of the present disclosure, when a fault of the FET occurs, it is possible to specify which FET among the plurality of FETs becomes faulty.

Next, operation of configuring the neutral point on the node N3 of the high-side of the first inverter 120 and performing the fault diagnosis is described.

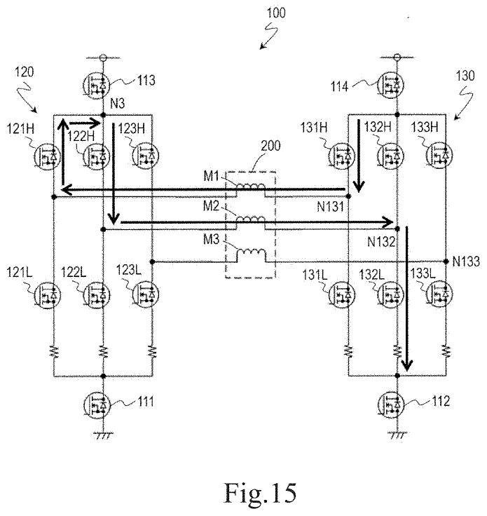

FIG. 15 is a view illustrating an example of an operation for configuring the neutral point and performing the fault diagnosis.

The control circuit 300 turns off the FETs 111 and 113 and turns on the FETs 112 and 114. In addition, the control circuit turns off the FETs 121L, 122L, and 123L, turns on the FETs 121H, 122H, and 123H, and configures the neutral point on the node N3.

In parallel with the operation for configuring the neutral point, the control circuit 300 turns on the FETs 131H and 132L and turns off the FETs 131L, 132H, 133L, and 133H. For this reason, a conductive path in which the FET 131H of the high-side of the second inverter 130, the U-phase winding M1, the neutral point (node N3), the V-phase winding M2, and the FET 132L of the low-side of the second inverter 130 are connected is configured. A voltage from the power source 101 is applied to this conductive path such that the current flows in the conductive path. Each of straight arrows represents the current flowing in the conductive path.

In the example shown in FIG. 15, the current flowing in the conductive path becomes a reverse current in the free-wheeling diode 140 of the FETs 122H, 131H, and 132L. That is, it is diagnosed whether the FETs 122H, 131H and 132L are faulty.

When the voltage of the node N131 is “high” and the voltage of the node N132 is “medium”, the microcontroller 340 judges that all the FETs 122H, 131H, and 132L are normal.

When all the voltages of the nodes N131 and N132 are “low”, the microcontroller 340 judges that the FET 131H is open-faulty.

When the voltage of the node N131 is “high” and the voltage of the node N132 is “low”, the microcontroller 340 judges that the FET 122H is open-faulty.

When all the voltages of the nodes N131 and N132 are “high”, the microcontroller 340 judges that the FET 132L is open-faulty.

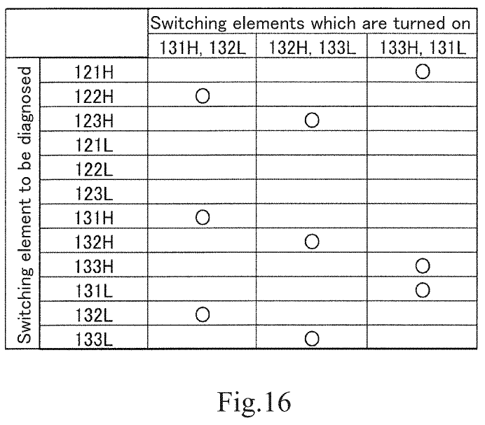

FIG. 16 is a view illustrating a relationship between the switching element which is turned on and the switching element to be diagnosed, in the second inverter 130 when the neutral point is configured on the high-side. In the table shown in FIG. 16, the switching elements which can be diagnosed with respect to the switching element which is turned on are indicated by white circles. In the example shown in FIG. 15, the FETs 131H and 132L are in a turned-on state, and it is possible to diagnose whether the FETs 122H, 131H and 132L are faulty.

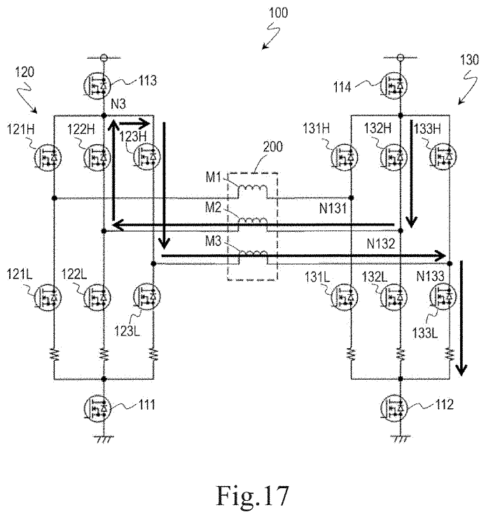

FIG. 17 is a view explaining the fault diagnosis when the FETs 132H and 133L are turned on. Similar to the example in FIG. 15, the control circuit 300 configures the neutral point on the node N3.

In parallel with the operation for configuring the neutral point, the control circuit 300 turns on the FETs 132H and 133L and turns off the FETs 131L, 131H, 132L, and 133H. For this reason, a conductive path in which the FET 132H of the high-side of the second inverter 130, the V-phase winding M2, the neutral point (node N3), the W-phase winding M3, and the FET 133L of the low-side of the second inverter 130 are connected is configured. A voltage from the power source 101 is applied to this conductive path so that the current flows in the conductive path. Each of straight arrows represents the current flowing in the conductive path.

In the example shown in FIG. 17, the current flowing in the conductive path becomes the reverse current in the free-wheeling diode 140 of the FETs 132H, 123H, and 133L. In the example shown in FIG. 17, it is diagnosed whether the FETs 132H, 123H, and 133L are faulty.

Similar to the above-described method, the microcontroller 340 determines whether a voltage of each of the nodes N132 and N133 is any one of “high”, “medium”, and “low” and then performs the fault diagnosis.

When the voltage of the node N132 is “high” and the voltage of the node N133 is “medium”, the microcontroller 340 judges that all the FETs 132H, 123H, and 133L are normal.

When all the voltages of the nodes N132 and N133 are “low”, the microcontroller 340 judges that the FET 132H is open-faulty.

When the voltage of the node N132 is “high” and the voltage of the node N133 is “low”, the microcontroller 340 judges that the FET 123H is open-faulty.

When all the voltages of the nodes N132 and N133 are “high”, the microcontroller 340 judges that the FET 133L is open-faulty.

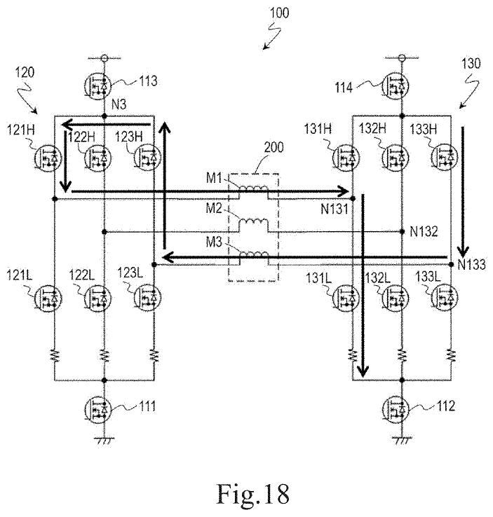

FIG. 18 is a view for explaining the fault diagnosis when the FETs 133H and 131L are turned on. Similar to the examples of FIGS. 15 and 17, the control circuit 300 configures the neutral point on the node N3.

In parallel with the operation for configuring the neutral point, the control circuit 300 turns on the FETs 133H and 131L and turns off the FETs 131H, 132L, 132H, and 133L. For this reason, a conductive path in which the FET 133H of the high-side of the second inverter 130, the W-phase winding M3, the neutral point (node N3), the U-phase winding M1, and the FET 131L of the low-side of the second inverter 130 are connected is configured. A voltage from the power source 101 is applied to this conductive path so that the current flows in the conductive path. Each of straight arrows represents the current flowing in the conductive path.

In the example shown in FIG. 18, the current flowing in the conductive path becomes the reverse current in the free-wheeling diode 140 of the FETs 133H, 121H, and 131L. In the example shown in FIG. 18, it is diagnosed whether the FETs 133H, 121H, and 131L are faulty.

Similar to the above-described method, the microcontroller 340 determines whether a voltage of each of the nodes N133 and N131 is any one of “high”, “medium”, and “low” and then performs the fault diagnosis.

When the voltage of the node N133 is “high” and the voltage of the node N131 is “medium”, the microcontroller 340 judges that all the FETs 133H, 121H, 131L are normal.

When all the voltages of the nodes N133 and N131 are “low”, the microcontroller 340 judges that the FET 133H is open-faulty.

When the voltage of the node N133 is “high” and the voltage of the node N131 is “low”, the microcontroller 340 judges that the FET 121H is open-faulty.

When all the voltages of the nodes N133 and N131 are “high”, the microcontroller 340 judges that the FET 131L is open-faulty.

As described above, according to the example embodiment of the present disclosure, it is possible to specify which FET among the plurality of FETs becomes faulty when a fault of the FET occurs.

In particular, as can be understood from FIGS. 12 and 16, by performing both the fault diagnosis in the state when the neutral point is configured on the low side and the fault diagnosis in the state when the neutral point is configured on the high side, the fault diagnosis for all of 12 FETs included in the first and second inverters 120 and 130 may be performed.

This makes it possible to specify the faulty FET, for example, even in the configuration in which the voltage between the source and the drain of the FET is not monitored as described above.

In addition, during control operation when the electric power conversion device 100 is normal, the above fault diagnosis may be performed by regularly configuring the neutral point. When the faulty FET is detected by the above fault diagnosis, “the control at the normal times” may be switched to “the control at the abnormal times”, and it is possible to continue to drive the motor 200.

Further, for example, even in a state when the fault has already occurred and the motor 200 is being driven by configuring the neutral point, the above fault diagnosis may be performed. For example, when the “control at the abnormal times” at which the neutral point is configured on the low-side of the first inverter 120 is being performed, it is possible to perform the fault diagnosis which has been described using FIGS. 10, 12, 13, and 14. In addition, for example, when the “control at the abnormal times” at which the neutral point is configured on the high-side of the first inverter 120 is being performed, it is possible to perform the fault diagnosis which has been described using FIGS. 15, 16, 17, and 18.

In the description of the above example embodiment of the present disclosure, the neutral point is configured in the first inverter 120 among the two inverters and then the fault diagnosis is performed. Even when the neutral point is configured in the second inverter 130, it is possible to perform the fault diagnosis as described above. In this case, the fault diagnosis can be performed by executing controls of the first inverter 120 and the second inverter 130 inversely as done in the above control.

A vehicle such as an automobile is generally provided with an electric power steering device. The electric power steering device generates an auxiliary torque for assisting a steering torque of a steering system generated by a driver operating a steering wheel. The auxiliary torque is generated by an auxiliary torque mechanism, and a burden on an operation of the driver can be reduced. For example, the auxiliary torque mechanism includes a steering torque sensor, an ECU, a motor, a speed reduction mechanism, and the like. The steering torque sensor detects a steering torque in the steering system. The ECU generates a driving signal on the basis of a detection signal of the steering torque sensor. The motor generates an auxiliary torque according to the steering torque based on the driving signal, and transmits the auxiliary torque to the steering system through the speed reduction mechanism.

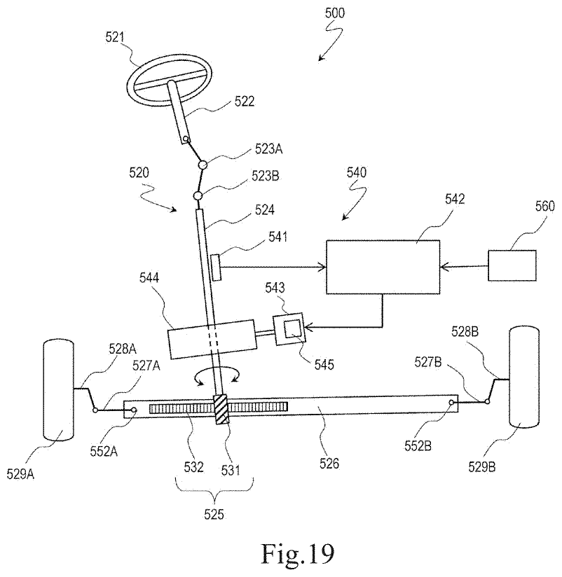

The motor driver 400 of the present disclosure is suitably used in an electric power steering device. FIG. 19 schematically shows a typical configuration of an electric power steering device 500 according to the example embodiment of the present disclosure. The electric power steering device 500 includes a steering system 520 and an auxiliary torque mechanism 540.

The steering system 520 includes, for example, a steering handle 521, a steering shaft 522 (also referred to as a “steering column”), universal joints 523A and 523B, a rotational axis 524 (also referred to as a “pinion axis” or an “input axis”), a rack and pinion mechanism 525, a rack axis 526, left and right ball joints 552A and 552B, tie rods 527A and 527B, knuckles 528A and 528B, and left and right steerable wheels (e.g., left and right front wheels) 529A and 529B. The steering handle 521 is connected to the rotational axis 524 through the steering shaft 522 and the universal joints 523A and 523B. The rack axis 526 is connected to the rotational axis 524 via the rack and pinion mechanism 525. The rack and pinion mechanism 525 includes a pinion 531 provided on the rotational axis 524 and a rack 532 provided on the rack axis 526. The right steerable wheel 529A is connected to a right end of the rack axis 526 through the ball joint 552A, the tie rod 527A, and the knuckle 528A in this order. Similar to the right side, the left steerable wheel 529B is connected to a left end of the rack axis 526 through the ball joint 552B, the tie rod 527B, and the knuckle 528B in this order. Here, the right side and the left side respectively coincide with a right side and a left side viewed from a driver seated in a seat.

According to the steering system 520, a steering torque is generated by the driver operating the steering handle 521, and is transmitted to the left and right steerable wheels 529A and 529B through the rack and pinion mechanism 525. For this reason, the driver can manipulate the left and right steerable wheels 529A and 529B.

The auxiliary torque mechanism 540 includes, for example, a steering torque sensor 541, an ECU 542, a motor 543, a speed reducing mechanism 544, and an electric power conversion device 545. The auxiliary torque mechanism 540 provides the steering system 520 encompassing from the steering handle 521 to the left and right steerable wheels 529A and 529B with an auxiliary torque. Also, the auxiliary torque may be referred to as an “additional torque”.

The control circuit 300 according to the first example embodiment of the present disclosure may be employed as the ECU 542, and the electric power conversion device 100 according to the first example embodiment may be employed as the electric power conversion device 545. Also, the motor 543 corresponds to the motor 200 in the first example embodiment. The motor driver 400 according to the first example embodiment may be suitably used as a mechanically and electrically integrated type unit including the ECU 542, the motor 543, and the electric power conversion device 545.

The steering torque sensor 541 detects the steering torque of the steering system 520 applied by the steering handle 521. The ECU 542 generates a driving signal for driving the motor 543 on the basis of a detected signal (hereinafter, represented as “torque signal”) from the steering torque sensor 541. The motor 543 generates an auxiliary torque according to the steering torque on the basis of the driving signal. The auxiliary torque is transmitted to the rotational axis 524 of the steering system 520 through the speed reducing mechanism 544. The speed reducing mechanism 544 is, for example, a worm gear mechanism. The auxiliary torque is also transmitted from the rotational axis 524 to the rack and pinion mechanism 525.

The electric power steering device 500 may be classified into a pinion assist type, a rack assist type, a column assist type, and the like, depending on a position at which the auxiliary torque is applied to the steering system 520. FIG. 19 illustrates the electric power steering device 500 of the pinion assist type. However, the electric power steering device 500 may be the rack assist type, the column assist type, or the like.

Not only a torque signal but also, for example, a vehicle speed signal may be inputted to the ECU 542. An external device 560 is, for example, a vehicle speed sensor. Alternatively, the external device 560 may be, for example, other ECU capable of communicating in a vehicle network such as a CAN (controller area network), and the like. The microcontroller of the ECU 542 may vector-control or PWM-control the motor 543 on the basis of the torque signal, the vehicle speed signal, or the like.

The ECU 542 sets a target current value on the basis of at least the torque signal. Preferably, the ECU 542 sets the target current value in consideration of the vehicle speed signal detected by the vehicle speed sensor and the rotational signal of the rotor detected by the angle sensor 320. The ECU 542 may control the driving current, that is, a driving signal of the motor 543 so that an actual current value detected by the current sensor (not shown) matches the target current value.

According to the electric power steering device 500, the left and right steerable wheels 529A and 529B may be operated by the rack axis 526 using a combined torque obtained by adding the auxiliary torque of the motor 543 to the steering torque of the driver. In particular, by using the motor driver 400 of the present disclosure in the above-described mechanically and electrically integrated type unit, the electric power steering device including the motor driver which improves quality of components and enables appropriate current control both at the normal times and the abnormal times is provided.

Features of the above-described example embodiments and the modifications thereof may be combined appropriately as long as no conflict arises.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1-17. (canceled)

18. An electric power conversion device to convert electric power from a power source into electric power to be supplied to a motor including an n-phase winding, where n is an integer greater than or equal to 3, the electric power conversion device comprising:
a first inverter connected to one end of each of the n-phase winding;
a second inverter connected to another end of each of the n-phase winding; and
a control circuit to control operation of the first and second inverters; wherein
each of the first and second inverters include a plurality of switching elements;
the n-phase winding includes a first-phase winding, a second-phase winding, and a third phase winding; and
the control circuit configures a neutral point in the first inverter and applies a voltage to a path in which a high-side of the second inverter, the first-phase winding, the neutral point, the second-phase winding, and a low-side of the second inverter are connected, and diagnoses whether the first and second inverters.

19. The electric power conversion device of claim 18, wherein the control circuit configures the neutral point in the first inverter and applies a voltage to a path in which a high-side of the second inverter, the second-phase winding, the neutral point, the third-phase winding, and a low-side of the second inverter are connected, and diagnoses whether the first and second inverters are faulty.

20. The electric power conversion device of claim 18, wherein the control circuit configures the neutral point in the first inverter and applies voltage to a path in which a high-side of the second inverter, the third-phase winding, the neutral point, the first-phase winding, and a low-side of the second inverter are connected, and diagnoses whether the first and second inverters are faulty.

21. The electric power conversion device of claim 18, wherein each of the plurality of switching elements includes a free-wheeling diode, and the control circuit diagnoses whether the switching element in which a current flowing when voltage is applied becomes a reverse current in the free-wheeling diode is faulty.

22. The electric power conversion device of claim 18, wherein
each of the first and second inverters includes a plurality of low-side switching elements and a plurality of high-side switching elements as the plurality of switching elements;
a first low-side switching element and a first high-side switching elements of the first inverter is connected to one end of the first-phase winding;
a second low-side switching element and a second high-side switching element of the first inverter are connected to one end of the second-phase winding;
a third low-side switching element and a third high-side switching element of the first inverter are connected to one end of the third-phase winding;
a fourth low-side switching element and a fourth high-side switching element of the second inverter are connected to the other end of the first-phase winding;
a fifth low-side switching element and a fifth high-side switching element of the second inverter are connected to the other end of the second-phase winding; and
a sixth low-side switching element and a sixth high-side switching element of the second inverter are connected to the other end of the third-phase winding.

23. The electric power conversion device of claim 22, wherein the control circuit:
configures the neutral point in the first inverter;
turns on the fourth high-side switching element and the fifth low-side switching element;
turns off the fourth low-side switching element, the fifth high-side switching element, the sixth low-side switching element, and the sixth high-side switching element; and
diagnoses whether the switching elements used to configure the neutral point in the first inverter, the fourth high-side switching element, and the fifth low-side switching element are faulty.

24. The electric power conversion device of claim 23, wherein the control circuit:
turns on the first low-side switching element, the second low-side switching element, and the third low-side switching element and configures the neutral point; and
diagnoses whether the first low-side switching element, the fourth high-side switching element, and the fifth low-side switching element are faulty.

25. The electric power conversion device of claim 22, wherein the control circuit:
configures the neutral point in the first inverter;
turns on the fifth high-side switching element and the sixth low-side switching element;
turns off the fourth low-side switching element, the fourth high-side switching element, the fifth low-side switching element, and the sixth high-side switching element; and
diagnoses whether the switching elements used to configure the neutral point in the first inverter, the fifth high-side switching element, and the sixth low-side switching element are faulty.

26. The electric power conversion device of claim 25, wherein the control circuit:
turns on the first low-side switching element, the second low-side switching element, and the third low-side switching element and configure the neutral point; and
diagnoses whether the second low-side switching element, the fifth high-side switching element, and the sixth low-side switching element are faulty.

27. The electric power conversion device of claim 22, wherein the control circuit:
configures the neutral point in the first inverter;
turns on the sixth high-side switching element and the fourth low-side switching element;
turns off the fourth high-side switching element, the fifth low-side switching element, the fifth high-side switching element, and the sixth low-side switching element; and
diagnoses whether the switching element used to configure the neutral point in the first inverter, the sixth high-side switching element, and the fourth low-side switching element are faulty.

28. The electric power conversion device of claim 27, wherein the control circuit:
turns on the first low-side switching element, the second low-side switching element, and the third low-side switching element and configure the neutral point; and
diagnoses whether the third low-side switching element, the sixth high-side switching element, and the fourth low-side switching element are faulty.

29. The electric power conversion device of claim 23, wherein the control circuit:
turns on the first high-side switching element, the second high-side switching element, and the third high-side switching element and configures the neutral point; and
diagnoses whether the second high-side switching element, the fourth high-side switching element, and the fifth low-side switching element are faulty.

30. The electric power conversion device of claim 25, wherein the control circuit:
turns on the first high-side switching element, the second high-side switching element, and the third high-side switching element and configures the neutral point; and
diagnoses whether the third high-side switching element, the fifth high-side switching element, and the sixth low-side switching element are faulty.

31. The electric power conversion device of claim 27, wherein the control circuit:
turns on the first high-side switching element, the second high-side switching element, and the third high-side switching element and configures the neutral point; and
diagnoses whether the first high-side switching element, the sixth high-side switching element, and the fourth low-side switching element are faulty.

32. The electric power conversion device of claim 18, wherein the control circuit diagnoses whether the fault occurs using at least two of voltage values of the first-phase, a voltage value of the second-phase, and a voltage value of the third-phase.

33. A motor driver comprising;
the electric power conversion device of claim 18; and
the motor.

34. An electric power steering device comprising the motor driver of claim 33.
